(19) United States
(12) Patent Application Publication
(10) Pub. No.: US 2016/0081310 A1
(43) Pub. Date: Mar. 24, 2016

(54) CONTAINER DEVICE

(71) Applicant: Bel-Art Products, Wayne, NJ (US)

(72) Inventors: Eva Winther, Pocomoke City, MD (US); Anthony L. Schnepel, Girdletree, MD (US)

(21) Appl. No.: 14/856,842

(22) Filed: Sep. 17, 2015

Related U.S. Application Data
(60) Provisional application No. 62/052,041, filed on Sep. 18, 2014.

(51) Int. Cl. A01K 63/00; A01G 9/02; B65D 25/20

(52) U.S. Cl. CPC A01K 63/003; B65D 25/20; A01G 9/02

(57) ABSTRACT

The present invention provides a container device having a silo and a screen assembly. The silo includes a top end, a bottom end and a side wall between the top end and the bottom end to define a volume. The screen assembly includes a screen member securely placed onto the silo. The screen member is interchangeable and removable from the silo.

### RELATED APPLICATIONS

This application claims the benefit of U.S. Provisional Application Ser. No. 62/052,041 filed Sep. 18, 2014, entitled, “Container Device”, the entire content of which is incorporated herein by reference.

### FIELD OF THE INVENTION

The present invention relates to field of container devices, and more particularly, to container devices for use in aquaculture.

### BACKGROUND OF THE INVENTION

Container devices such as silos used for aquaculture farming are well known in the art. Such silos are typically used by farmers for cultivation of aquaculture products such as aquatic animals and plants. Currently such silos include a mesh screen, which is glued to the silo. Each of the mesh screens are made of different sizes to accommodate for growth states of the aquaculture products. During farming season, when the aquatic animal or a plant needs to be graded and set, the aquatic animal or plant is moved from one silo to another silo of a larger screen size to accommodate the growth in size of the aquatic animal or plant.

Current silos have many disadvantages. One such disadvantage is that manufacturing of such silos require an extensive amount of time and labor. Also, in order to accommodate for rotations of the aquatic animals or plants, a large number of silos are need to be manufactured, which could be very expensive. Further, a lot of storage space is required to store such large number of silos.

Thus, there is a need in the art to provide for a container device having a silo and a screen, which is cost efficient requiring least amount of time and labor to manufacture. There is also a need in the art to provide for the container device, which may be used multiple times during different processes of the grading of the aquaculture products.

### SUMMARY OF THE INVENTION

The present invention overcomes the disadvantages of the current silos by providing a container device, which is designed to have a removable and interchangeable screen, details of which are provided herein below.

According to one aspect of the invention, there is provided a container device, which includes a silo and a screen assembly. In one embodiment, the silo may be cylindrical in shape with two opposing ends. The silo having an opening at each of the opposing ends.

In one embodiment, the screen assembly having a mesh is attached to the silo for retaining of aquaculture products. In one embodiment, the screen assembly is removable from the silo. In one embodiment, the screen assembly is interchangeable such that another screen assembly of a mesh size different from mesh size of the screen assembly is attached to the silo.

In one embodiment, the screen assembly includes a screen member and a rim enclosing the screen member. In one embodiment, the rim includes at least two apertures. In one embodiment, the screen member is made of various sizes and accommodates to close one of the openings of the silo. In one embodiment, the screen member is interchangeable and removable from the silo. As such, many various sizes of screen members may connect to the silo to accommodate for various sizes of the aquaculture products such as aquatic animals and plants. This results in saving time during the grading such that only screens may be rotated with the same silo. As such, fewer silos will be needed and many more screens members may need to be manufactured. This results in cost saving of the manufacturing of the container device. Also, less storage space may be needed due to storing of more screen members and very few silos.

In one embodiment, the openings of the silo are substantially circular in shape and the screen member is substantially circular in shape to accommodate for closure of the opening of the silo. In one embodiment, the screen assembly includes at least two rods having a threaded end and a hook end such that the threaded end is inserted into the aperture of the rim of the screen member and the hook end is inserted into the other opening of the silo.

In a further embodiment, the screen assembly includes at least two knobs inserted into the threaded end of the each of the two rods to securely and firmly attach the screen member to the silo.

### BRIEF DESCRIPTION OF THE DRAWINGS

FIG. 1 is a schematic view of parts of a container device in accordance with an embodiment of the present application.

FIG. 2A illustrates assembly of the parts of the container device of FIG. 1 in accordance with the embodiment of the present application.

FIG. 2B illustrates assembly of the parts of the container device of FIG. 1 in accordance with the embodiment of the present application.

FIG. 2C illustrates assembly of the parts of the container device of FIG. 1 in accordance with the embodiment of the present application.

FIG. 2D illustrates assembly of the parts container device of FIG. 1 in accordance with the embodiment of the present application.

FIG. 2E illustrates a final assembly of the container device of FIG. 1 in accordance with the embodiment of the present application.

In a further embodiment, the screen assembly includes at least two knobs inserted into the threaded end of the each of the two rods to securely and firmly attach the screen member to the silo.

### DETAILED DESCRIPTION OF THE INVENTION

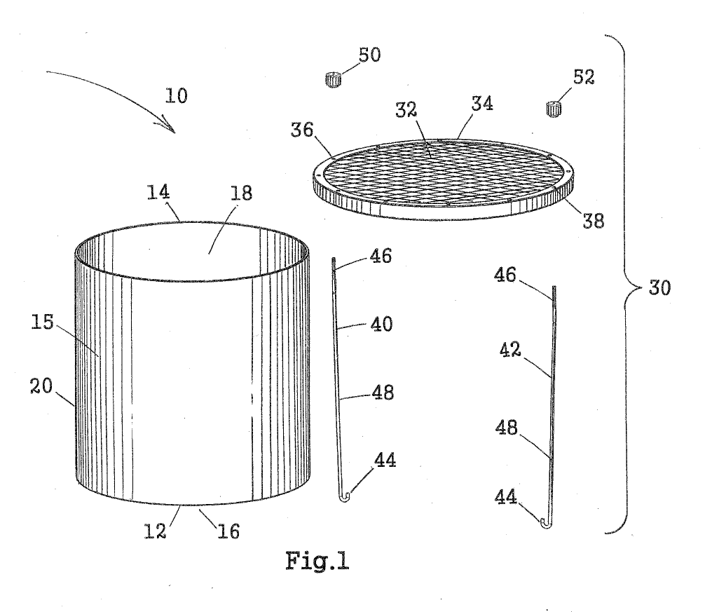

Referring to FIG. 1, there is shown a container device 10 having a silo 20 and a screen assembly 30 in accordance with an embodiment of the present invention. In one embodiment, the silo 20 may have cylindrical body preferably made of plastic or steel material or combinations of both materials. The silo 20 includes a top end 12 and a bottom end 14 and a sidewall 15 between the top end 12 and the bottom end 14 arranged to define a volume, which is cylindrical in shape. In one embodiment, the top end 12 of the silo 20 includes a top opening 16, which is shaped and sized to accommodate for insertion of aquaculture products. Such aquaculture products include but are not limited to aquatic plants and animals. As shown in FIG. 1, the top opening 16 of the silo 20 is substantially circular in shape. In one embodiment, the bottom end 14 of the silo 20 includes a bottom opening 18. The bottom opening 18 of the silo 20 is also substantially circular in shape. In one embodiment, the bottom opening 18 of the silo 20 allows for secure placement of the screen assembly 30 as described herein below.

Also, shown in FIG. 1 is the screen assembly 30 having a screen member 32 enclosing a rim 34. In one embodiment, the rim 34 includes at least two apertures 36 and 38 at opposing ends of the rim 34. The screen member 32 may have a substantially circular shape to provide for closure of the bottom opening 18 of the silo 20. The screen member 32 includes a mesh made of plastic or steel material or combinations of both materials. The screen member 32 may include various mesh sizes to accommodate for various types of grading of the aquaculture products during farming season. The mesh sizes may include but are not limited to 200 mm, 300 mm, and 750 mm. In one embodiment, the screen members 32 are uniquely identified based on the mesh sizes. Such unique identity may include a color. As such, each screen member 32 is coated with a different color to identify the mesh size of the screen member 32. Another unique identity may include a number. As such, each screen member 32 is labeled with a number to identify the mesh size of the screen.

In one embodiment, the screen member 32 having different mesh sizes may be securely placed onto the same silo 20. As such, the screen assembly 30 provides for interchangeable screen members 32. In one embodiment, the screen member 32 having different mesh sizes may be securely placed onto different silos 20. Some examples of mesh sizes include 200 microns, 200 microns, 500 microns, 750 microns etc.

Further as shown in FIG. 1, the screen assembly 30 also includes at least two rods 40 and 42, both that are identical in shape and having two opposing ends. In one embodiment, each of the two rods 40 and 42 include a hook portion 44 at one end and a threaded portion 46 at the other end with an elongated portion 48 between the hook portion 44 and the threaded portion 46. In one embodiment, the screen assembly 30 includes at least two knobs 50 and 52 each of which having an opening to securely place the knobs 50 and 52 onto the threaded portion 46 of the rods 40 and 42 respectively as will be described in greater detail below.

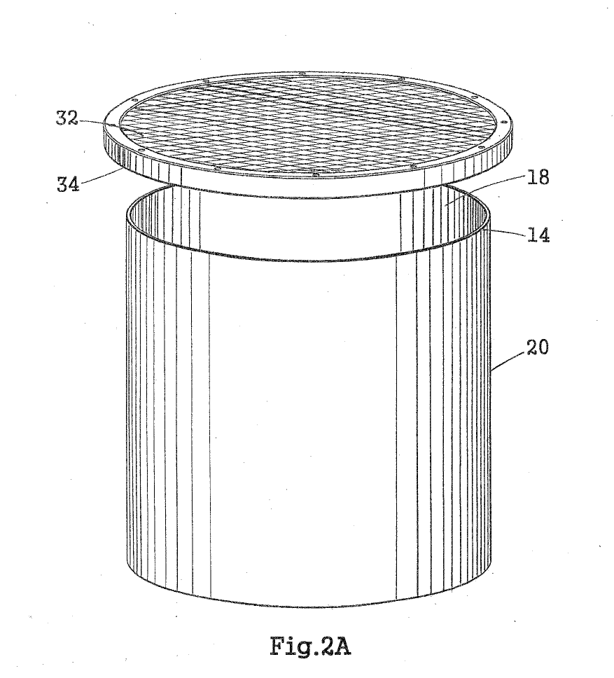

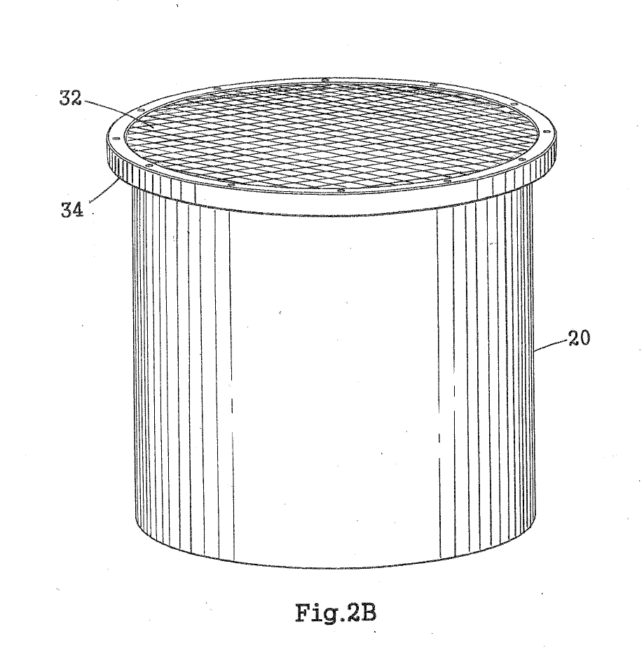

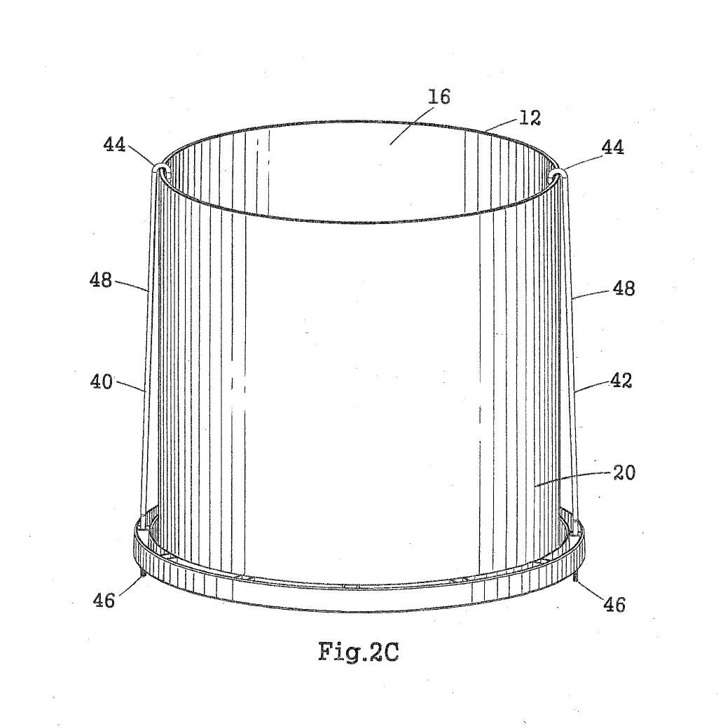

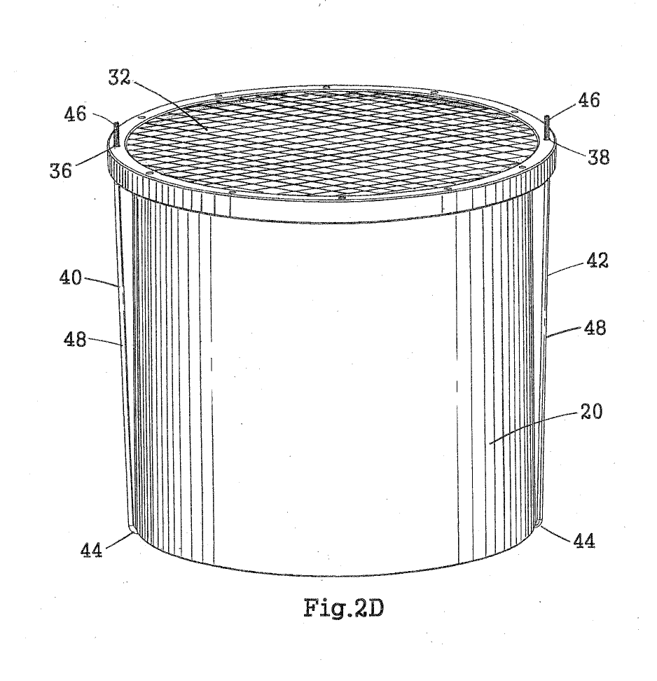

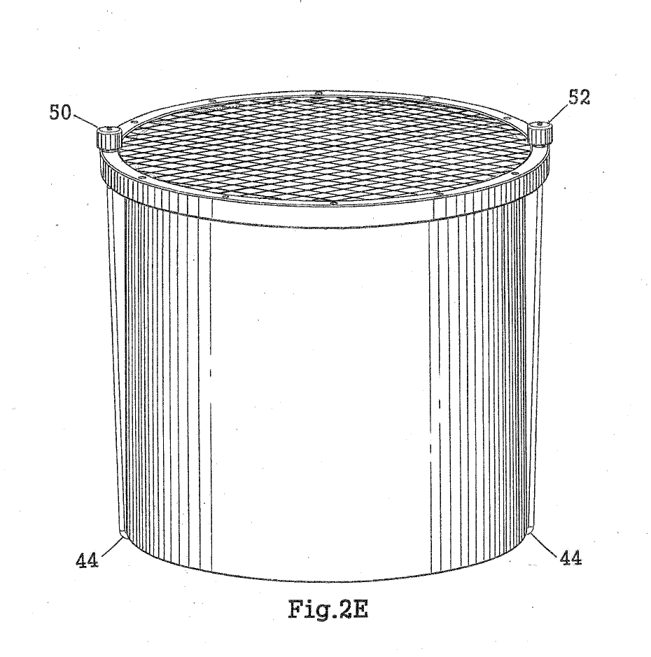

In one embodiment, as illustrated in FIG. 2A, the screen member 32 is being placed on the bottom end 14 of the silo 20. As such, the screen member 32 functions to close the bottom opening 18 of the silo 20 as illustrated in FIG. 2B.

In another embodiment, as illustrated in FIG. 2C, the hook portion 44 of each of the rods 40 and 42 are placed inside the top opening 16 of the silo 20. As such, the hook portion 44 of each of the rods 40 and 42 securely rest against inner portion of the sidewall 15 of the silo 20. Also, as shown in FIG. 2D, the threaded portion 46 of each of the two rods 40 and 42 are inserted into the apertures 36 and 38 respectively of the rim 34 of the screen member 32. As such, the threaded portion 44 of each of the two rods 40 and 42 protrudes from their respective apertures 36 and 38 of the rim 34. Also, as shown in FIG. 2D, the elongated portion 48 of each of the two rods 40 and 42 hang against the outer portion of the sidewall 15.

In a further embodiment, as illustrated in FIG. 2E, the at least two knobs 50 and 52 each of which having an opening are inserted onto the threaded portion 46 of the rods 40 and 42 respectively. In one embodiment, the knobs 50 and 52 may be rotated (clockwise or counterclockwise) to tighten the rods 40 and 42 onto the rim 34 of the screen member 32. As such, the screen assembly 30 is firmly and securely attached to the silo 20.

In one embodiment, the screen assembly 30 is removable from the silo 20. In one embodiment, the screen member 32 of the screen assembly 30 is removable from the silo 20. The knobs 50 and 52 may be rotated (clockwise or counterclockwise) to remove them from the threaded portion 46 of the rods 40 and 42 and from the rim 34 of the screen member 32. Then, the screen member 32 may be pulled from the bottom opening of the silo 20. As such, the screen member 32 may be easily removed from the silo.

After removal of the screen member, each of the rods 40 and 42 may be pulled from the silo 20 by holding onto the elongated portion 48 and with very little force or pressure pulling the hook portion 44 of each of the rods 40 and 42 out from the bottom opening 18 of the silo 20, each of which would result in the threaded portion 46 of each of the rods 40 and 42 being removed from their respective apertures 36 and 38 of the rim 34. Then, the screen member 32 may be pulled out from bottom opening 16 of the silo 20. As such, the screen assembly 30 may be easily removed from the silo 20.

It will be appreciated by those skilled in the art that changes could be made to the embodiments described above without departing from the broad inventive concept thereof. It will be understood, therefore, that this invention is not limited to the particular embodiments disclosed, but is intended to cover modifications within the spirit and scope of the present invention as defined by the appended claims.

1. A container device comprising:
a silo having a top end, a bottom end and a side wall between the top end and the bottom end to define a volume; and
a screen assembly comprising a screen member securely placed onto the silo, wherein the screen member is interchangeable and removable from the silo.

2. The container device of claim 1 wherein the screen member is placed at the bottom end of the silo.

3. The container device of claim 2 wherein the bottom end of the silo comprises a bottom opening and the screen member is configured to close the bottom opening.

4. The container device of claim 3 wherein the screen assembly further comprises at least two rods, wherein each of the two rods comprising two opposing ends, wherein one end of the opposing end having a hook portion and other of the opposing end having a threaded portion with an elongated portion between the hook portion and the threaded portion.

5. The container device of claim 4 wherein the top portion of the silo comprises a top opening and the hook portion of each of the at least two rods are placed inside the top opening of the silo such that the hook portion of the each of the at least two rods securely rest against inner portion of the sidewall of the silo.

5. The container device of claim 4 wherein the screen member comprises a rim having at least two apertures at opposing ends of the rim.

6. The container device of claim 5 wherein the threaded portion of each of the at least two rods are inserted into the at least two apertures of the rim such that the threaded portion of each of the at least two rods protrude from the at least two apertures of the rim.

7. The container device of claim 6 wherein the screen assembly comprises at least two knobs, each of the two knobs having an opening to insert into the threaded portion of each the at least two rods.

8. The container device of claim 7 wherein each of the at least two knobs are rotated in a first direction to tighten each of the at least two rods onto the rim of the screen member to firmly and securely attach the screen member to the silo.

9. The container device of claim 8 wherein each of the at least two knobs are rotated in a second direction to remove the at least two knobs from the threaded portion of the at least two rods and the rim of the screen member, wherein the second direction is opposite to the first direction.

10. The container device of claim 9 wherein the screen member is removed from the bottom opening of the silo.

11. The container device of claim 10 wherein the at least two rods are removed from the silo.

12. The container device of claim 1 wherein the screen member comprises a mesh of various sizes.

13. The container device of claim 1 wherein the mesh is made from a plastic material, a steel material or combination of both the plastic and the steel material.

14. The container device of claim 14 wherein the solo is cylindrical in shape

15. The container device of claim 1 wherein the screen member is substantially circular in shape.
